(19) United States
(12) Patent Application Publication
(10) Pub. No.: US 2020/0133312 A1
(43) Pub. Date: Apr. 30, 2020

(54) SOLENOID VALVE CONTROL APPARATUS AND CONTROL METHOD OF SOLENOID VALVE

(71) Applicant: AISIN SEIKI KABUSHIKI KAISHA, Kariya-shi (JP)

(72) Inventors: Hiroshi MINATO, Kariya-shi (JP); Kazuyoshi SHIMATANI, Kariya-shi (JP); Yoshinobu UCHIYAMA, Kariya-shi (JP)

(73) Assignee: AISIN SEIKI KABUSHIKI KAISHA, Kariya-shi (JP)

(21) Appl. No.: 16/655,693

(22) Filed: Oct. 17, 2019

(30) Foreign Application Priority Data
Oct. 26, 2018 (JP) 2018-201862

(51) Int. Cl. G05D 7/06; G05B 19/416

(52) U.S. Cl. CPC G05D 7/0623; G05B 2219/45006; G05B 19/416

(57) ABSTRACT

A solenoid valve control apparatus includes a basic electric current value set portion configured to set a basic electric current value every first cycle, a dither electric current value set portion configured to set a dither electric current value of which a cycle corresponds to a dither cycle, a target electric current value set portion configured to set a target electric current value, an electric current detection portion configured to detect an actual electric current value, a duty ratio set portion configured to set a duty ratio every second cycle which is longer than the dither cycle, and a PWM control portion configured to perform PWM control on the solenoid on the basis of the duty ratio.

### CROSS REFERENCE TO RELATED APPLICATIONS

This application is based on and claims priority under 35 U.S.C. § 119 to Japanese Patent Application 2018-201862, filed on Oct. 26, 2018, the entire content of which is incorporated herein by reference.

### TECHNICAL FIELD

This disclosure generally relates to a solenoid valve control apparatus and a control method of a solenoid valve.

### BACKGROUND DISCUSSION

A known solenoid valve has been conventionally used when flow of fluid is controlled. At a solenoid valve, an electromagnetic valve or solenoid valve is opened and closed by electric current flowing in a solenoid. Here, to move a valve body of the solenoid valve in a state where the valve body is stopped and still, static friction acts on the valve body. To continuously move the valve body that has already been moving, the static friction does not act. Accordingly, even if electric current including the equal electric current value is supplied to the solenoid of the solenoid valve in a state where the valve body is moving and to the solenoid of the solenoid valve in a state where the valve is stopped, a difference arises in opening degrees of the solenoid valves between these states, which may possibly influence characteristics. Thus, according to a known technique, the electric current flowing in the solenoid is varied periodically and the valve body is slightly vibrated regardless of the open state or closed state of the solenoid valve in order to reduce the static friction (for example, JP2014-197655A which will be referred also to Patent reference 1).

In Patent reference 1, an electric current control apparatus controlling exciting current of a solenoid is described. The electric current control apparatus includes a target setting section, a duty ratio setting section, and a PWM signal generating section. The target setting section sets a value which varies periodically in a dither cycle that is longer than a PWM cycle corresponding to a pulse period of a PWM signal generated by the PWM signal generating section, as a target electric current value corresponding to a target value of the exciting current. The duty ratio setting section sets a duty ratio of the PWM signal on the basis of the target electric current value. A cycle in which the target setting section sets the target electric current value and a cycle in which the duty ratio setting section sets the duty ratio are configured to be shorter than the dither cycle. Thus, the dither generated in the dither cycle is accurately reflected in the target electric current value and an FB control portion of the duty ratio setting section performs negative feedback control on the basis of the target electric current value reflecting the dither.

It is generally said that an appropriate control cannot be performed unless a setting cycle of the duty ratio is sufficiently short relative to the dither cycle, in order to output the electric current to which the dither is applied. Thus, in the technique described in Patent reference 1, the setting cycle of the duty ratio needs to be short according to the dither cycle, which may possibly increase a calculation load on the electric current control apparatus significantly. In this case, it is possible that costs need to be increased as a high-performance calculation apparatus is needed and/or the solenoid valve is not controlled as the calculation cannot be performed.

A need thus exists for a solenoid valve control apparatus and a control method of a solenoid valve which are not susceptible to the drawback mentioned above.

### SUMMARY

According to an aspect of this disclosure, a solenoid valve control apparatus includes a basic electric current value set portion configured to set a basic electric current value of electric current supplied to a solenoid of a solenoid valve, the basic electric current value is according to a required output required of the solenoid valve, and the basic electric current value is set every first cycle. The solenoid valve control apparatus includes a dither electric current value set portion configured to set a dither electric current value of which a cycle corresponds to a dither cycle and a target electric current value set portion configured to set a target electric current value of the electric current supplied to the solenoid. The target electric current value is set on the basis of the basic electric current value and the dither electric current value. The solenoid valve control apparatus includes an electric current detection portion configured to detect an actual electric current value of electric current actually flowing in the solenoid, a duty ratio set portion configured to set a duty ratio on the basis of the target electric current value and the actual electric current value every second cycle which is longer than the dither cycle Td, and a PWM control portion configured to perform PWM control on the solenoid on the basis of the duty ratio.

According to another aspect of this disclosure, a control method of a solenoid valve includes setting a basic electric current value of electric current supplied to a solenoid of a solenoid valve. The basic electric current value is according to a required output required of the solenoid valve and the basic electric current value is set every first cycle. The method includes setting a dither electric current value of which a cycle corresponds to a dither cycle and setting a target electric current value of the electric current supplied to the solenoid. The target electric current value is set on the basis of the basic electric current value and the dither electric current value. The method includes detecting an actual electric current value of electric current actually flowing in the solenoid, setting a duty ratio on the basis of the target electric current value and the actual electric current value every second cycle which is longer than the dither cycle, and performing PWM control on the solenoid on the basis of the duty ratio.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view indicating a configuration of a solenoid valve control apparatus according to an embodiment disclosed here; and

FIG. 2 is an example of a time chart according to the embodiment.

### DETAILED DESCRIPTION

A solenoid valve control apparatus of the present disclosure is configured to control a solenoid valve appropriately. A solenoid valve control apparatus 1 of an embodiment disclosed here will be described hereunder with reference to the drawings.

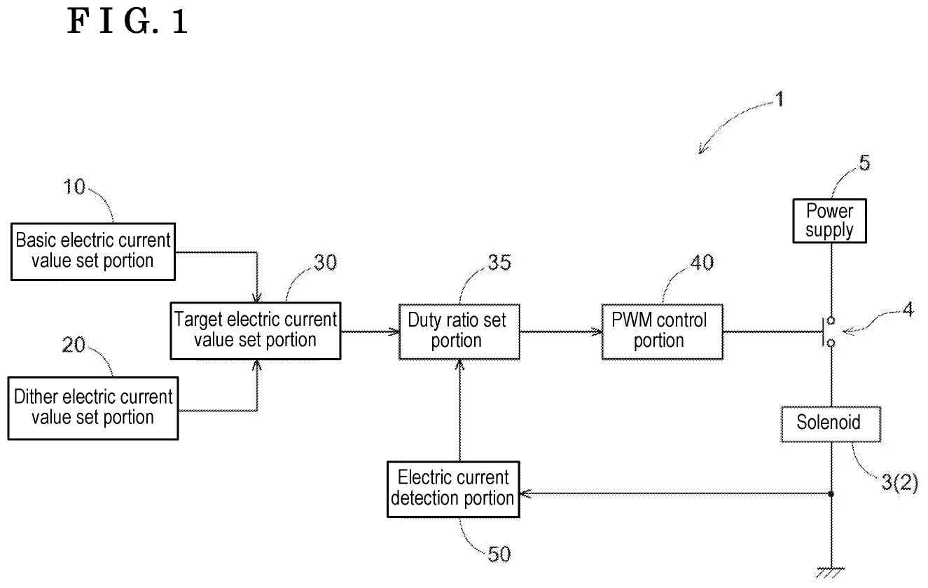

FIG. 1 is a block diagram schematically illustrating a configuration of the solenoid valve control apparatus 1 of the embodiment. The solenoid valve control apparatus 1 is provided with function portions including a basic electric current value set portion 10, a dither electric current value set portion 20, a target electric current value set portion 30, a duty ratio set portion 35, a PWM control portion 40, and an electric current detection portion 50. The function portions are configured of hardware or software or both of hardware and software, in a manner that a CPU serves as a core member so that the function portions perform processing related to control of a solenoid valve 2.

The basic electric current value set portion 10 sets, in every first cycle T1, a basic electric current value of electric current supplied to or electrifying a solenoid 3 of the solenoid valve 2. The basic electric current value is in accordance with a required output required of the solenoid valve 2. The required output required of the solenoid valve 2 is an output that equipment to which fluid controlled by the solenoid valve 2 is supplied requires relative to the solenoid valve 2, and corresponds to a flow amount (a discharge amount) of the fluid which is to be discharged from the solenoid valve 2. The required output is transmitted from other system (the above-described equipment and/or a control unit, for example) which is different from the solenoid valve control apparatus 1.

As is known, a valve body of the solenoid valve 2 is moved when the solenoid 3 is electrified or energized, and a flow amount of the fluid flowing at the solenoid valve 2 is controlled. An amount of movement of the valve body at this time is in accordance with magnitude or an amount of electric current supplied to the solenoid 3. Therefore, the basic electric current value set portion 10 sets the electric current value of the electric current to be supplied to the solenoid 3 such that a flow amount and/or pressure of the fluid discharged from the solenoid valve 2 meets or achieves the required output transmitted from other system. In the embodiment, the electric current value is called a basic electric current value.

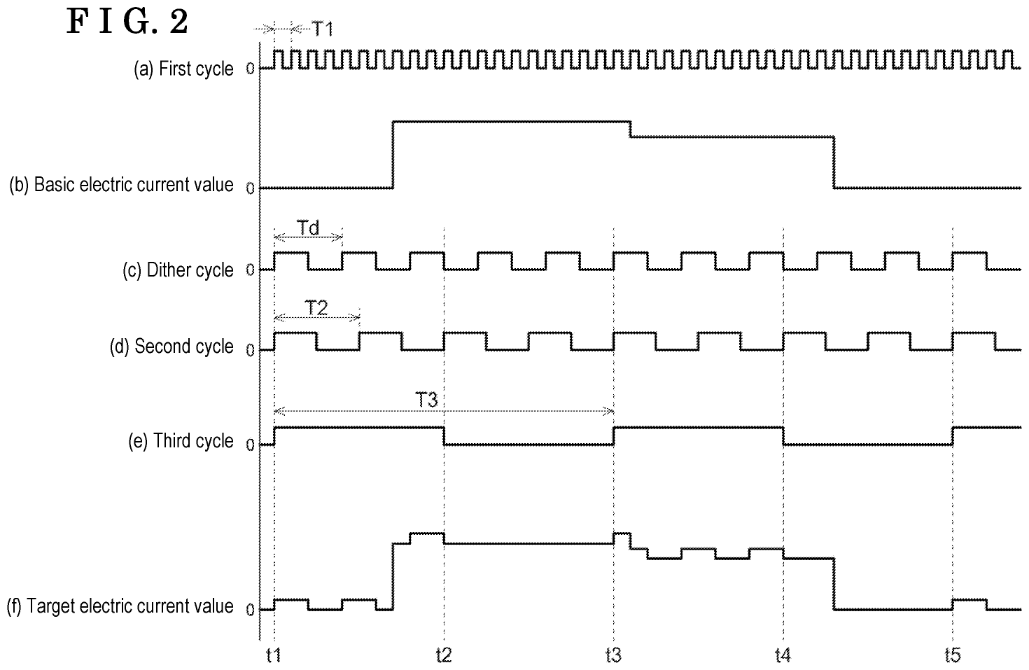

O O 2 O FIG. 2 shows a timing chart of processing performed by the solenoid valve control apparatus 1. The basic electric current value set portion 10 sets the basic electric current value in every first cycle T1 that is predetermined and indicated by (a) of FIG. 2. An example of the basic electric current value set by the basic electric current value set portion 10 is indicated by (b) of FIG. 2. In the explanation of the embodiment, the first cycle T1 is 10 milliseconds, however, the first cycle T1 is not limited a specific value.

A process of setting, every first cycle T1, the basic electric current value of the electric current supplied to the solenoid 3 of the solenoid valve 2 which is in accordance with the required output required of the solenoid valve 2 corresponds to a basic electric current value setting process of the control method of the solenoid valve.

As illustrated in FIG. 1, the dither electric current value set portion 20 sets a dither electric current value whose cycle is a dither cycle Td. Setting the dither electric current value whose cycle is the dither cycle Td is setting an electric current value (dither electric current value) of electric current (dither electric current) that periodically changes or varies in the predetermined dither cycle Td. The above-described electric current value of the electric current corresponds to the dither electric current value. The dither electric current value set portion 20 sets the dither electric current value in the dither cycle Td set in advance which is indicated by (c) of FIG. 2.

According to the solenoid valve control apparatus 1, electric current formed of an electric current value (which corresponds to a target electric current value that will be described below) configured by superimposing the dither electric current value on the basic electric current value set by the basic electric current value set portion 10 is supplied to the solenoid 3 regardless of an opening degree of the solenoid valve 2, and thereby the valve body is slightly vibrated. The dither electric current value may be set in advance depending on an environmental temperature of the solenoid valve 2 or temperature of the fluid of which the flow is controlled by the solenoid valve 2, for example. In such cases, the dither electric current value set portion 20 sets the dither electric current value in accordance with the environmental temperature of the solenoid valve 2 or the temperature of the fluid of which the flow is controlled by the solenoid valve 2.

In the embodiment, the dither cycle Td is set to be a cycle which is longer than the first cycle T1. In the explanation of the embodiment, the dither cycle Td is 40 milliseconds, however, the dither cycle Td is not limited a specific value.

A process of setting the dither electric current value including the dither cycle Td corresponds to a dither electric current value setting process of the control method of the solenoid valve.

The target electric current value set portion 30 sets the target electric current value of the electric current supplied to the solenoid 3, on the basis of the basic electric current value and the dither electric current value. The basic electric current value is set by the basic electric current value set portion 10 and is transmitted. The dither electric current value is set by the dither electric current value set portion 20 and is transmitted. The target electric current value set portion 30 superimposes the dither electric current value on the basic electric current value, that is, the target electric current value set portion 30 sets the target electric current value by adding the dither electric current value to the basic electric current value.

As will be described in detail later, the target electric current value set portion 30 does not always superimpose the dither electric current value on the basic electric current value. The target electric current value set portion 30 superimposes the dither electric current value on the basic electric current value in some cases and does not superimpose the dither electric current value on the basic electric current value in other cases. According to the embodiment, in a case where the dither electric current value is superimposed on the basic electric current value, the electric current of the basic electric current value is changed periodically due to the dither electric current value and the electric current value periodically changing corresponds to the target electric current value. On the other hand, in a case where the dither electric current value is not superimposed on the basic electric current value, the electric current of the basic electric current value is not changed periodically due to the dither electric current value and the basic electric current value corresponds to the target electric current value.

A process of setting the target electric current value of the electric current supplied to the solenoid 3 on the basis of the basic electric current value and the dither electric current value corresponds to a target electric current value setting process of the control method of the solenoid valve.

The electric current detection portion 50 detects an actual electric current value of the electric current that is actually flowing at the solenoid 3. The actual electric current value of the electric current that is actually flowing at the solenoid 3 is an electric current value of electric current that is actually flowing at the solenoid 3 at that point of time. The detection of the actual electric current value can be performed with the use of a known method including detection by an electric current sensor and/or a resistor, for example. The actual electric current value detected by the electric current detection portion 50 is transmitted to the duty ratio set portion 35 that will be described below.

A process of detecting the actual electric current value of the electric current that is actually flowing at the solenoid 3 corresponds to an electric current detecting process of the control method of the solenoid valve.

The duty ratio set portion 35 sets, in every second cycle T2, a duty ratio on the basis of the target electric current value and the actual electric current value. The second cycle T2 is longer than the dither cycle Td. The target electric current value is set by the target electric current value set portion 30 and is transmitted. The actual electric current value is detected by the electric current detection portion 50 and is transmitted. In the embodiment, as illustrated in FIG. 1, a switch 4 is provided between an electric power source 5 and the ground potential. The switch 4 is connected in series to the solenoid 3. By causing the switch 4 to be in a closed state, electric current of an intended electric current value is supplied to the solenoid 3. The switch 4 may be configured by using a transistor, for example. In the embodiment, the duty ratio described above corresponds to a ratio of a time period during which the switch 4 is in the closed state relative to the second cycle T2. In the embodiment, as illustrated in FIG. 2, the second cycle T2 is set to be a cycle which is longer than the dither cycle Td and shorter than two cycles of the dither cycle Td. The duty ratio set portion 35 sets the duty ratio in every second cycle T2.

A process of setting, in every second cycle T2 that is longer than the dither cycle Td, the duty ratio on the basis of the target electric current value and the actual electric current value corresponds to a duty ratio setting process of the control method of the solenoid valve.

The PWM control portion 40 controls the solenoid 3 with a PWM (Pulse Width Modulation) control on the basis of the duty ratio. The duty ratio is set by the duty ratio set portion 35 and is transmitted. The duty ratio is set by the duty ratio set portion 35 and is transmitted. As the PWM control is conventionally known, the explanation thereof is omitted here accordingly. In the embodiment, the PWM control portion 40 PWM-controls the switch 4 in the second cycle T2 that is longer than the dither cycle Td. That is, the PWM control portion 40 performs the PWM control at a switching frequency of 1/T2 hertz. In the embodiment, the explanation is made using the dither cycle Td of 40 milliseconds. In the embodiment, 50 milliseconds is used as the second cycle T2 (refer to (d) of FIG. 2).

As described above, the duty ratio used for the PWM control is set on the basis of the actual electric current value of the electric current actually flowing at the solenoid 3. Thus, in the PWM control, the PWM control is performed in a manner that the electric current value of the electric current actually flowing through the solenoid 3 (the actual electric current value) is fed back to the PWM control portion 40.

A process of performing the PWM control to the solenoid 3 on the basis of the duty ratio corresponds to a PWM controlling process of the control method of the solenoid valve.

As described above, the target electric current value set portion 30 of the solenoid valve control apparatus 1 according to the embodiment does not always superimpose the dither electric current value on the basic electric current value. The target electric current value set portion 30 superimposes the dither electric current value on the basic electric current value in some cases and does not superimpose the dither electric current value on the basic electric current value in other cases, which will be described specifically.

At the solenoid valve control apparatus 1, the control is performed in a manner that the function portions follow the first cycle T1, the dither cycle Td, the second cycle T2 and a third cycle T3. The first cycle T1 is the cycle in which the basic electric current value set portion 10 sets the basic electric current value as described above. The dither cycle Td is the cycle in which the dither electric current value set portion 20 sets the dither electric current value as described above. The second cycle T2 is the cycle in which the duty ratio set portion 35 sets the duty ratio as described above. The third cycle T3 is a cycle in which the target electric current value set portion 30 makes a switch or changeover on whether or not the dither electric current value is superimposed on the basic electric current value.

That is, in the embodiment, the third cycle T3 is configured of a superimposed time period and a not-superimposed time period. In the superimposed time period, the electric current value of the electric current supplied to the solenoid 3 periodically changes or varies in accordance with the target electric current value set by the target electric current value set portion 30 by superimposing the dither electric current value on the basic electric current value. In the not-superimposed time period, the electric current value of the electric current supplied to the solenoid 3 does not periodically change or vary in accordance with the target electric current value set by the target electric current value set portion 30 without superimposing the dither electric current value on the basic electric current value.

In the embodiment, the third cycle T3 is set to be a cycle configured of the least common multiple of the dither cycle Td and the second cycle T2. As described above, the dither cycle Td is 40 milliseconds and the second cycle T2 is 50 milliseconds in the embodiment. Accordingly, in the embodiment, the third cycle T3 is set at 200 milliseconds as indicated by (e) of FIG. 2. The target electric current value set portion 30 may be configured to store in advance that the third cycle T3 is 200 milliseconds. Here, to facilitate the understanding of the disclosure, the explanation will be made in a manner that the first half of the third cycle T3 is superimposed time period and the latter half of the third cycle T3 is the not-superimposed time period.

In FIG. 2, a chronological change of the target electric current value set by the target electric current value set portion 30 is indicated by (f). In FIG. 2, the first half of the third cycle T3 is a time period from a time t1 to a time t2 and a time period from a time t3 to a time t4. The latter half of the third cycle T3 is a time period from the time t2 to the time t3 and a time period from the time t4 to a time t5. Thus, a time period from the time t1 to the time t3 corresponds to the third cycle T3 (a time period from the time t3 to the time t5).

In the time period from the time t1 to the time t2, the target electric current value set portion 30 superimposes the dither electric current value on the basic electric current value indicated by (b) of FIG. 2 such that the electric current value is changed periodically in accordance with the dither cycle Td indicated by (c) of FIG. 2. Thus, in the time period from the time t1 to the time t2, the electric current value in which the dither electric current value is superimposed on the basic electric current value is used as the target electric current value.

On the other hand, in the time period from the time t2 to the time t3, the target electric current value set portion 30 does not superimpose the dither electric current value on the basic electric current value indicated by (b) of FIG. 2. Thus, in the time period from the time t2 to the time t3, the electric current value, on which the dither electric current value is not superimposed, is used as the target electric current value.

In a similar manner, in the time period from the time t3 to the time t4, the electric current value in which the dither electric current value is superimposed on the basic electric current value is used as the target electric current value. In the time period from the time t4 to the time t5, the basic electric current value on which the dither electric current value is not superimposed is used as the target electric current value. As described above, in the embodiment, the third cycle T3 includes the superimposed time period where the target electric current value, which is set by superimposing the dither electric current value on the basic electric current value, changes in a cyclic manner according to the dither cycle Td, and the not-superimposed time period where the target electric current value, which is set by not superimposing the dither electric current value on the basic electric current value, does not change according to the dither cycle Td.

Due to the above-described configurations, at the solenoid valve control apparatus 1 of the embodiment, the cycle (an actual dither cycle) in which the dither is actually applied is the third cycle T3 (200 milliseconds), and the second cycle T2 (50 milliseconds) corresponding to the setting cycle on which the duty ratio is set can be made to be sufficiently short relative to the actual dither cycle. Thus, the solenoid valve 2 can be appropriately controlled. According to the solenoid valve control apparatus 1 of the embodiment, a calculation load is not significantly increased, and accordingly, for example, a high-performance calculation apparatus does not need to be used for performing the above-described control of the embodiment. Consequently, cost increase will not occur. As described above, according to the solenoid valve control apparatus 1 of the embodiment, the solenoid valve 2 can be controlled appropriately without increasing the costs.

Other embodiment will be described hereunder. In the explanation of the aforementioned embodiment, the first half of the third cycle T3 is the superimposed time period and the latter half of the third cycle T3 is the not-superimposed time period. However, the first half of the third cycle T3 may be the not-superimposed time period and the latter half of the third cycle T3 may the superimposed time period. The superimposed time period and the not-superimposed time period may be set to include different time periods from each other. In this case, for example, a predetermined ratio may be set in advance, and a time period of each of the superimposed time period and the not-superimposed time period may be set on the basis of the predetermined ratio.

In the explanation of the aforementioned embodiment, the target electric current value set portion 30 makes the switch on whether or not the dither electric current value is superimposed on the basic electric current value, however, the target electric current value set portion 30 may always superimpose the dither electric current value on the basic electric current value. That is, the target electric current value set portion 30 may set the target electric current value by always adding the dither electric current value to the basic electric current value.

In the explanation of the aforementioned embodiment, the dither cycle Td is the cycle that is longer than the first cycle T1. However, the dither cycle Td may be a cycle that is equal to the first cycle T1 or the dither cycle Td may be a cycle that is shorter than the first cycle T1.

In the explanation of the aforementioned embodiment, the second cycle T2 is the cycle that is longer than the dither cycle Td and shorter than two cycles of the dither cycle Td. However, the second cycle T2 may be a cycle that is longer than the dither cycle Td and longer than two cycles of the dither cycle Td.

In the explanation of the aforementioned embodiment, the third cycle T3 is the cycle that is formed of the least common multiple of the dither cycle Td and the second cycle T2. However, the third cycle T3 may be a cycle which is not the least common multiple of the dither cycle Td and the second cycle T2. For example, the third cycle T3 may be a cycle which is formed of the second common multiple of the dither cycle Td and the second cycle T2, or a subsequent common multiple of the dither cycle Td and the second cycle T2 such as the third common multiple, for example. The third cycle T3 may be a cycle that is not a common multiple of the dither cycle Td and the second cycle T2.

In the explanation of the aforementioned embodiment, the first cycle T1 is 10 milliseconds, the dither cycle Td is 40 milliseconds, the second cycle T2 is 50 milliseconds and the third cycle T3 is 200 milliseconds. However, the above-described values are examples and may be set at other values.

The present disclosure is applicable to a solenoid valve control apparatus controlling the drive or actuation of a solenoid valve, and a control method of the solenoid valve.

According to the aforementioned embodiment, a solenoid valve control apparatus 1 includes a basic electric current value set portion 10 configured to set a basic electric current value of electric current supplied to a solenoid 3 of a solenoid valve 2, the basic electric current value is according to a required output required of the solenoid valve 2, and the basic electric current value is set every first cycle T1. The solenoid valve control apparatus 1 includes a dither electric current value set portion 20 configured to set a dither electric current value of which a cycle corresponds to a dither cycle Td and a target electric current value set portion 30 configured to set a target electric current value of the electric current supplied to the solenoid 3. The target electric current value is set on the basis of the basic electric current value and the dither electric current value. The solenoid valve control apparatus 1 includes an electric current detection portion 50 configured to detect an actual electric current value of electric current actually flowing in the solenoid 3, a duty ratio set portion 35 configured to set a duty ratio on the basis of the target electric current value and the actual electric current value every second cycle T2 which is longer than the dither cycle Td, and a PWM control portion 40 configured to perform PWM control on the solenoid 3 on the basis of the duty ratio.

According to the above-described configuration, the duty ratio set portion 35 can set the duty ratio in every second cycle T2 that is longer than the dither cycle Td. Thus, the solenoid valve 2 can be operated in a state where the dithering is applied in a similar manner to a conventional case, while a frequency of calculation of the duty ratio, which results in a high calculation load, is reduced.

According to the aforementioned embodiment, the dither cycle Td corresponds to a cycle which is longer than the first cycle T1.

According to the above-described configuration, even in a case where circumstances of the solenoid valve 2 changes from time to time, the basic electric current value set portion 10 can set an appropriate basic electric current value that is in accordance with the circumstances of the solenoid valve 2. Consequently, on the basis of the basic electric current value and the dither electric current value, the appropriate target electric current value can be set.

According to the aforementioned embodiment, the second cycle T2 corresponds to a cycle which is longer than the dither cycle Td and shorter than two cycles of the dither cycle Td.

According to the above-described configuration, the dither including even shorter cycle can be applied to the solenoid valve 2, while the calculation load is reduced.

According to the aforementioned embodiment, the target electric current value set portion 30 makes a switch, in every third cycle T3, on whether or not the dither electric current value is superimposed on the basic electric current value.

According to the above-described configuration, a time period in which the dither electric current value is not superimposed on the basic electric current value is provided, and thus a load placed on the solenoid valve 2 can be reduced.

According to the aforementioned embodiment, the third cycle T3 corresponds to a cycle configured of a least common multiple of the dither cycle Td and the second cycle T2.

According to the above-described configuration, a cycle (an actual dither cycle) in which the dither is actually applied is the third cycle T3. Accordingly, the second cycle T2, which corresponds to the setting cycle in which the duty ratio is set, can be made sufficiently short relative to the actual dither cycle. Thus, the solenoid valve 2 can be controlled appropriately.

According to the aforementioned embodiment, a control method of a solenoid valve includes setting a basic electric current value of electric current supplied to a solenoid 3 of a solenoid valve 2. The basic electric current value is according to a required output required of the solenoid valve 2 and the basic electric current value is set every first cycle T1. The method includes setting a dither electric current value of which a cycle corresponds to a dither cycle Td and setting a target electric current value of the electric current supplied to the solenoid 3. The target electric current value is set on the basis of the basic electric current value and the dither electric current value. The method includes detecting an actual electric current value of electric current actually flowing in the solenoid 3, setting a duty ratio on the basis of the target electric current value and the actual electric current value every second cycle T2 which is longer than the dither cycle Td, and performing PWM control on the solenoid 3 on the basis of the duty ratio.

According to the aforementioned embodiment, the control method of the solenoid valve does not include substantial difference from the above-described solenoid valve control apparatus, and the effects similar to the solenoid valve control apparatus can be obtained by the control method of the solenoid valve.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A solenoid valve control apparatus comprising:
a basic electric current value set portion configured to set a basic electric current value of electric current supplied to a solenoid of a solenoid valve, the basic electric current value being according to a required output required of the solenoid valve, the basic electric current value being set every first cycle;
a dither electric current value set portion configured to set a dither electric current value of which a cycle corresponds to a dither cycle;
a target electric current value set portion configured to set a target electric current value of the electric current supplied to the solenoid, the target electric current value being set on the basis of the basic electric current value and the dither electric current value;
an electric current detection portion configured to detect an actual electric current value of electric current actually flowing in the solenoid;
a duty ratio set portion configured to set a duty ratio on the basis of the target electric current value and the actual electric current value every second cycle which is longer than the dither cycle; and
a PWM control portion configured to perform PWM control on the solenoid on the basis of the duty ratio.

2. The solenoid valve control apparatus according to claim 1, wherein the dither cycle corresponds to a cycle which is longer than the first cycle.

3. The solenoid valve control apparatus according to claim 1, wherein the second cycle corresponds to a cycle which is longer than the dither cycle and shorter than two cycles of the dither cycle.

4. The solenoid valve control apparatus according to claim 2, wherein the second cycle corresponds to a cycle which is longer than the dither cycle and shorter than two cycles of the dither cycle.

5. The solenoid valve control apparatus according to claim 1, wherein the target electric current value set portion makes a switch on whether or not the dither electric current value is superimposed on the basic electric current value every third cycle.

6. The solenoid valve control apparatus according to claim 5, wherein the third cycle corresponds to a cycle configured of a least common multiple of the dither cycle and the second cycle.

7. A control method of a solenoid valve, the method comprising:
setting a basic electric current value of electric current supplied to a solenoid of a solenoid valve, the basic electric current value being according to a required output required of the solenoid valve, the basic electric current value being set every first cycle;
setting a dither electric current value of which a cycle corresponds to a dither cycle;
setting a target electric current value of the electric current supplied to the solenoid, the target electric current value being set on the basis of the basic electric current value and the dither electric current value;
detecting an actual electric current value of electric current actually flowing in the solenoid;
setting a duty ratio on the basis of the target electric current value and the actual electric current value every second cycle which is longer than the dither cycle; and
performing PWM control on the solenoid on the basis of the duty ratio.
